(19) United States
(12) Patent Application Publication
(10) Pub. No.: US 2013/0006663 A1
(43) Pub. Date: Jan. 3, 2013

(54) LOCATION-BASED SERVICES FOR PATIENTS

(75) Inventors: Brian Bertha, Danville, CA (US); Darren O'Neill, San Francisco, CA (US); Stan Kachnowski, Tarrytown, NY (US); Margaret Griffin, New York, NY (US); Ilene Hollin, New York, NY (US)

(73) Assignee: MCKESSON SPECIALTY ARIZONA INC.

(21) Appl. No.: 13/172,487

(22) Filed: Jun. 29, 2011

(51) Int. Cl. G06Q 50/00

(52) U.S. Cl. 705/3

(57) ABSTRACT

Systems, methods, apparatus, and computer program products are provided for providing at least one message to a patient. In one embodiment, healthcare data may indicate (and/or be used to identify) a patient that has had a prescription filled by a care provider. Messaging to the patient's mobile device can then be provided based on the mobile device's location with regard to the care provider's location.

### BACKGROUND

Poor adherence to medication therapy, abandonment of prescriptions (e.g., prescriptions not picked up after being filled), and the high cost of recruitment of patients for clinical trials are problems for pharmacy businesses, drug wholesalers, and the overall costs of healthcare. Pharmacists, providers, and payers have employed various techniques to reduce these problems. These techniques include providing patients with reminders, disease management programs, incentives, and/or rebates. Unfortunately, such techniques have not been successful in changing patient behavior. Thus, there is a need to provide location-based and time-relevant messages to patients regarding prescriptions and other information.

### BRIEF SUMMARY

In general, embodiments of the present invention provide systems, methods, apparatus, and computer program products for providing at least one message to a patient.

In accordance with one aspect, a method for providing at least one message to a patient is provided. In one embodiment, the method comprises (1) receiving healthcare data for a prescription, wherein the healthcare data (a) identifies a patient associated with the prescription and (b) a care provider associated with filling the prescription; (2) monitoring the location of a mobile device of the patient to determine whether the mobile device has entered a geofenced area associated with the care provider; (3) after determining the mobile device has entered the geofenced area associated with the care provider, generating a message for the patient; and (4) providing the message to the mobile device of the patient.

In accordance with another aspect, a computer program product for providing at least one message to a patient is provided. The computer program product may comprise at least one computer-readable storage medium having computer-readable program code portions stored therein, the computer-readable program code portions comprising executable portions configured to (1) receive healthcare data for a prescription, wherein the healthcare data (a) identifies a patient associated with the prescription and (b) a care provider associated with filling the prescription; (2) monitor the location of a mobile device of the patient to determine whether the mobile device has entered a geofenced area associated with the care provider; (3) after determining the mobile device has entered the geofenced area associated with the care provider, generate a message for the patient; and (4) provide the message to the mobile device of the patient.

In accordance with yet another aspect, an apparatus comprising at least one processor and at least one memory including computer program code is provided. In one embodiment, the at least one memory and the computer program code may be configured to, with the processor, cause the apparatus to at least (1) receive healthcare data for a prescription, wherein the healthcare data (a) identifies a patient associated with the prescription and (b) a care provider associated with filling the prescription; (2) monitor the location of a mobile device of the patient to determine whether the mobile device has entered a geofenced area associated with the care provider; (3) after determining the mobile device has entered the geofenced area associated with the care provider, generate a message for the patient; and (4) provide the message to the mobile device of the patient.

### BRIEF DESCRIPTION OF THE SEVERAL VIEWS OF THE DRAWING(S)

Reference will be made to the accompanying drawings, which are not necessarily drawn to scale, and wherein:

FIG. 1 is a diagram of a system that can be used to practice various embodiments of the present invention.

FIG. 2 is a schematic of a server that may be used in association with certain embodiments of the present invention.

FIG. 3 is a schematic of a mobile device that may be used in association with certain embodiments of the present invention.

FIG. 4 is a flowchart illustrating operations and processes that can be used in accordance with various embodiments of the present invention.

FIGS. 5A, 5B, and 5C show exemplary input and output that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. METHODS, APPARATUS, SYSTEMS, AND COMPUTER PROGRAM PRODUCTS

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. EXEMPLARY SYSTEM ARCHITECTURE

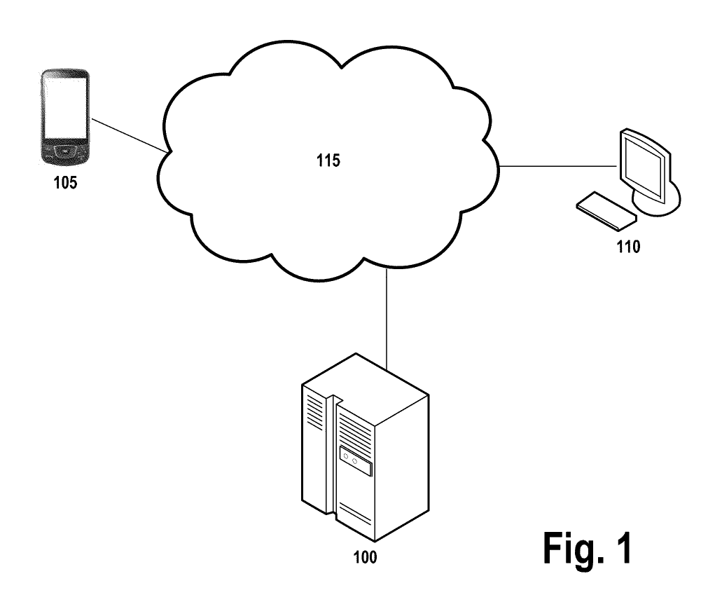

FIG. 1 provides an illustration of a system that can be used in conjunction with various embodiments of the present invention. As shown in FIG. 1, the system may include one or more servers 100, one or more mobile devices 105, one or more care provider computing devices 110, and one or more networks 115. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture.

### 1. Exemplary Server

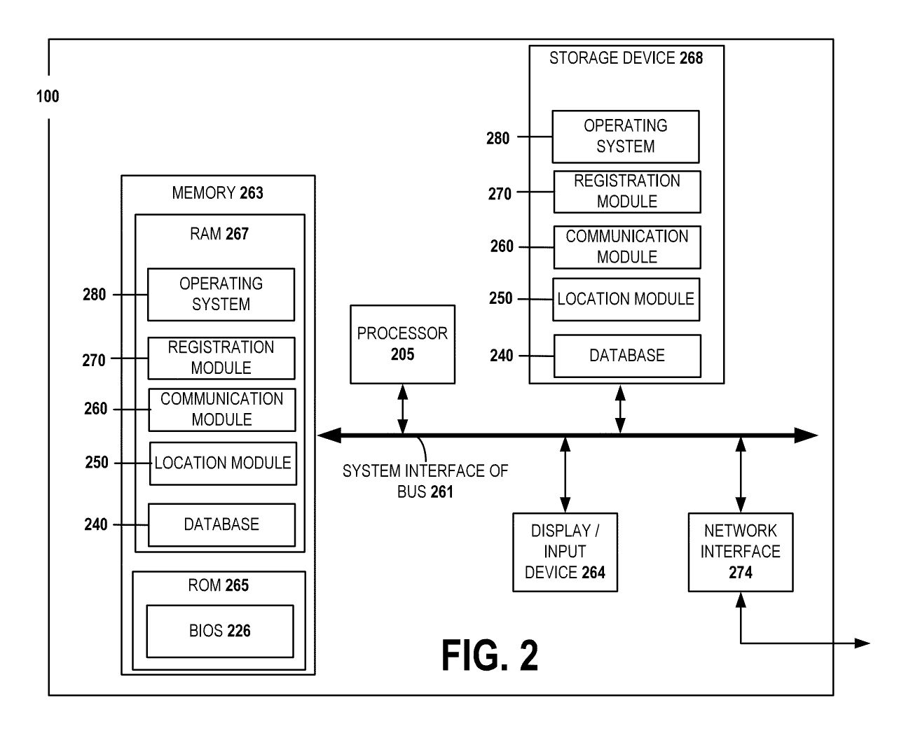

FIG. 2 provides a schematic of a server 100 according to one embodiment of the present invention. In some embodiments, the server 100 may be associated with an organization engaged in healthcare-related services. For example, the server 100 may be associated with an organization (e.g., care provider or third-party organization) providing a service associated with facilitating operation of a program for providing location-based and time-relevant messages to patients.

In general, the term “server” may refer to, for example, any computer, computing device, mobile phone, desktop, tablet, notebook or laptop, distributed system, server, blade, gateway, switch, processing device, or combination of processing devices adapted to perform the functions described herein. As will be understood from this figure, in one embodiment, the server 100 includes a processor 205 that communicates with other elements within the server 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the server 100. This display device/input device 264 may be, for example, a keyboard or pointing device that is used in combination with a monitor. The server 100 may further include transitory and non-transitory memory 263, which may include both random access memory (RAM) 267 and read only memory (ROM) 265. The server's ROM 265 may be used to store a basic input/output system (BIOS) 226 containing the basic routines that help to transfer information to the different elements within the server 100.

In addition, in one embodiment, the server 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, a registration module 270, a communication module 260, and a location module 250. As discussed in more detail below, these executable instructions, applications, program modules, and/or the like may control certain aspects of the operation of the server 100 with the assistance of the processor 205 and operating system 280—although their functionality need not be modularized. In addition to the program modules, the server 100 may store or be in communication with one or more databases, such as database 240.

Also located within the server 100, in one embodiment, is a network interface 274 for interfacing with various computing entities (e.g., with one or more mobile devices 105 and/or care provider computing devices 110). For example, the server 100 may be able to receive data/messages from and transmit data/messages to the mobile device 105. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the server 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the server's 100 components may be located remotely from other server 100 components. Furthermore, one or more of the components may be combined and additional components performing functions described herein may be included in the server 100.

### 2. Exemplary Mobile Device

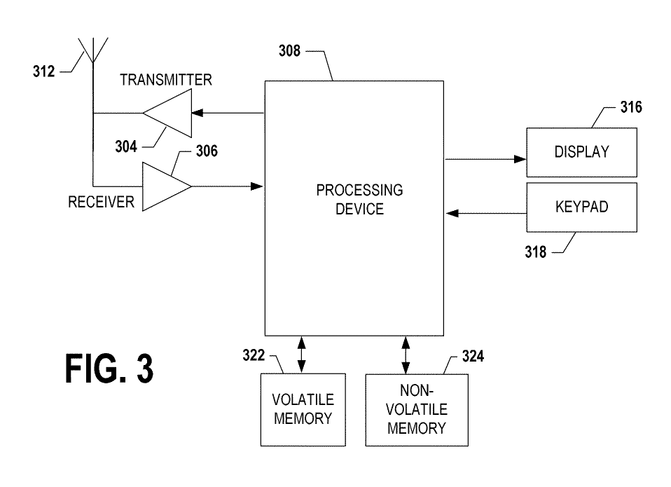

FIG. 3 provides an illustrative schematic representative of a mobile device 105 that can be used in conjunction with the embodiments of the present invention. In some embodiments, mobile devices 105 may be associated with patients of care providers, such as patients who have had prescriptions filled at a pharmacy. In general, the term “mobile device” may refer to, for example, any computer, computing device, mobile phone, desktop, tablet, notebook or laptop, processing device, or combination of processing devices adapted to perform the functions described herein. For example, as shown in FIG. 3, the mobile device 105 can include an antenna 312, a transmitter 304 (e.g., radio), a receiver 306 (e.g., radio), and a processing device 308 (e.g., a processor, controller, and/or the like) that provides signals to and receives signals from the transmitter 304 and receiver 306, respectively.

The signals provided to and received from the transmitter 304 and the receiver 306, respectively, may include signaling information in accordance with an air interface standard of applicable wireless systems. In this regard, the mobile device 105 may be capable of operating with one or more air interface standards, communication protocols, modulation types, and access types. More particularly, the mobile device 105 may operate in accordance with any of a number of wireless communication standards and protocols, such as those described above with regard to the server 100. In a particular embodiment, the mobile device 105 may operate in accordance with multiple wireless communication standards and protocols (e.g., using a Gobi radio), such as GSM, UMTS, 1xRTT, and EVDO, and use multiple wireless carriers (e.g., China Mobile, Vodafone, Telefonica, T-Mobile, Verizon, AT&T, and Qtel). To do so, the mobile device 105 may include integrated mobile reception diversity and integrated power management. Such a configuration can provide for global connectivity to the user.

Via these communication standards and protocols, the mobile device 105 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The mobile device 105 can also download changes, add-ons, and updates, for instance, to its firmware, software (e.g., including modules), and operating system.

According to one embodiment, the mobile device 105 may include a location determining device and/or functionality. For example, the mobile device 105 may include a Global Positioning System (GPS) module adapted to acquire, for example, location data (e.g., latitude, longitude, altitude, geocode, course, speed, and/or ephemeris data). In one embodiment, the GPS module may acquire location data by identifying the number of satellites in view and the relative positions of those satellites. Additionally or alternatively, triangulation may be used in connection with the mobile device 105 and with various communication points (e.g., cellular towers or Wi-Fi access points) positioned at various locations throughout a geographic area to determine the location of the mobile device 105.

The mobile device 105 may also comprise a user interface (that can include a display 316 coupled to a processing device 308) and/or a user input interface (coupled to the processing device 308). The user input interface can comprise any of a number of devices allowing the mobile device 105 to receive data, such as a keypad 318, a touch display, voice or motion interfaces, or other input device. In embodiments including a keypad 318, the keypad 318 can include the conventional numeric (0-9) and related keys (#, *), and other keys used for operating the mobile device 105 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 105 can also include volatile memory 322 and/or non-volatile memory 324, which can be embedded and/or may be removable. For example, the non-volatile memory may be embedded or removable MMCs, secure digital SD memory cards, Memory Sticks, EEPROM, flash memory, hard disk, and/or the like. The memory can store any of a number of pieces or amount of information and data used by the mobile device 105 to implement the functions of the mobile device 105. The memory can also store content, such as computer program code for an application and/or other computer programs.

### 3. Exemplary Care Provider Computing Device

Care providers may be doctors, hospitals, pharmacies, insurance providers, care managers, and/or other healthcare-related entities or professionals. Care providers may be associated with one or more different care provider computing devices 110 that may be used in connection with embodiments of the present invention. The care provider computing devices 110 may each include one or more components that are functionally similar to those of the server 100 and/or mobile device 105. For example, in one embodiment, each of the care provider computing device 110 may include: (1) a processor that communicates with other elements via a system interface or bus; (2) a display device/input device; (3) transitory and non-transitory memory; and (4) a communications interface. These architectures are provided for exemplary purposes only and are not limiting to the various embodiments. The term “computing device” is used generically to refer to any computer, computing device, mobile phone, desktop, notebook or laptop, distributed system, server, blade, gateway, switch, processing device, or combination of processing devices adapted to perform the functions described herein.

### III. EXEMPLARY SYSTEM OPERATION

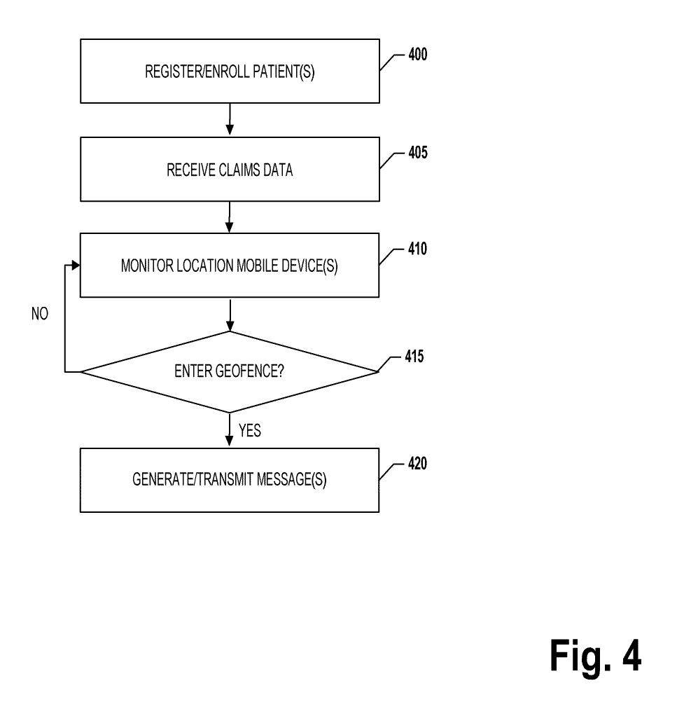

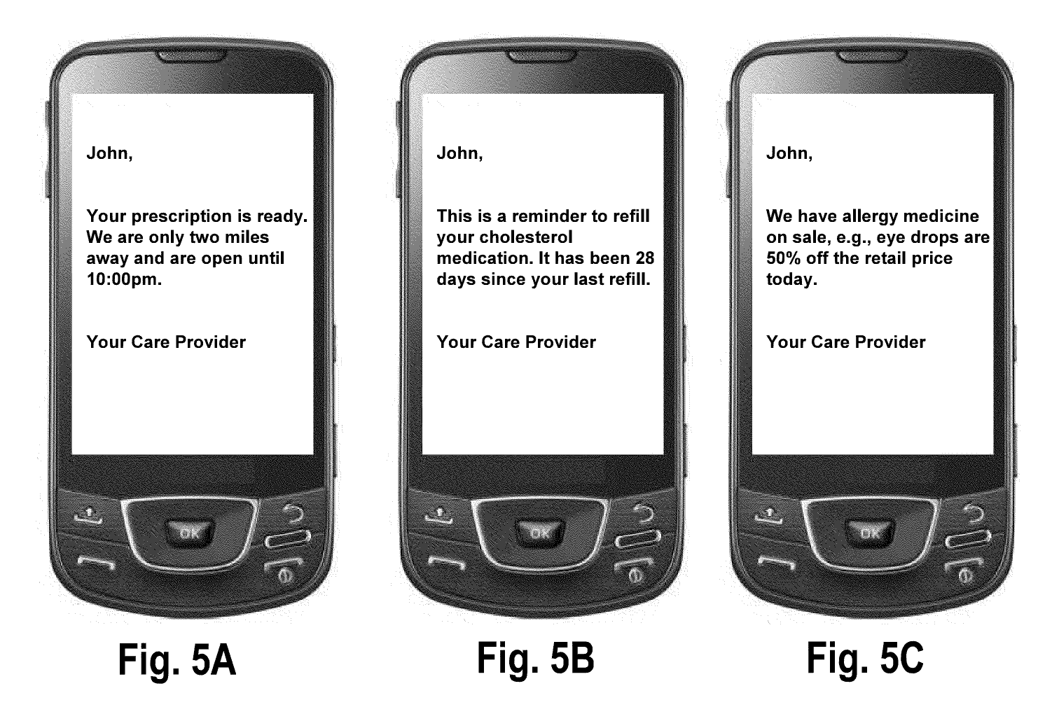

Reference will now be made to FIGS. 4, 5A, 5B, and 5C. FIG. 4 illustrates operations and processes that can be performed for location-based services for patients. FIGS. 5A, 5B, and 5C illustrate exemplary input and output produced by various embodiments of the present invention.

### 1. Registration

In one embodiment, as indicated in Block 300 of FIG. 3, the process may begin with the enrollment/registration for location-based services by one or more patients. A patient may be an individual, a family, a company, an organization, an entity, a department within an organization, a representative of an organization and/or person, and/or the like. The location-based services may include, for example, transmitting messages to the patient regarding a prescription until the prescription is picked up or until a predetermined time period has lapsed (e.g., two weeks). In one embodiment, the predetermined time period may correspond to the time the filled prescription may remain in a holding rack at a pharmacy before being restocked.

In one embodiment, a patient (e.g., a patient or patient representative operating a patient computing device) may access a webpage or portal of a care provider to enroll/register for location-based services. In another embodiment, a patient may download and install an application for location-based services on a mobile device 105. Via the application, the patient may be able to provide communications preferences and view messages. In yet another embodiment, a care provider (e.g., a care provider or care provider representative operating a care provider computing device 110) may enroll/register patients for location-based services. For example, a care provider may enroll/register patients for location-based services as a result of the patients requesting such services by filling out a form. Or, a care provider may automatically enroll/register all patients for location-based services, unless they opt out. As will be recognized, a variety of other techniques and approaches may be used with embodiments of the present invention.

In one embodiment, as part of the enrollment/registration process, a patient may be requested to provide biographic information. Thus, the patient may provide the patient's name, address, date of birth, medical/customer identification number, health insurance information, Social Security number, and/or the like. By way of example, a patient may provide the following information: (1) Name: John Smith; (2) Address: 75 Fourteenth Street, Atlanta, Ga. 30309; (3) Date of Birth: Feb. 19, 1970; (4) Customer Identification Number: BR1254897.1; and/or (5) Social Security number: 534-21-5841.

In one embodiment, a patient may also provide communication preferences. The communication preferences for a patient may identify one or more mobile devices 105 for location-based services. The communication preferences may also provide patients with the ability to request and receive messages via the one or more mobile devices 105. The communication preferences may also identify one or more communication formats for communicating with the patient (e.g., providing messages to the appropriate mobile devices 105). The communication formats may include text messages (e.g., Short Message Service (SMS) and/or Multimedia Messaging Service (MMS)), email messages, voice messages, messages viewed using a software application resident on the mobile device 105, and/or a variety of other messages in various communication formats. In addition to identifying one or more communication formats, a patient can provide the electronic destination addresses (corresponding to the communication formats) to be used in providing location-based services to the patient. For instance, for text messages, the patient may provide the phone number associated with one or more mobile devices 105. For email messages, the patient may provide one or more email addresses for email accounts that are accessible via one or more mobile devices 105. For voice messages, the patient may provide one or more phone numbers for which voice messages can be retrieved via one or more mobile devices 105. And for messages to be viewed using a software application resident on one or more mobile devices 105, the electronic destination addresses may be Internet Protocol (IP) addresses, BlackBerry personal identification numbers, screen names, usernames, International Mobile Subscriber Identity numbers (IMSI), Integrated Circuit Card IDs (ICCID), Electronic Serial Numbers (ESN), Mobile Equipment Identifiers (MEID), and/or the like.

In one embodiment, based on the biographic information and the communication preferences, the server 100 (and/or other computing device) may create a patient profile for each enrolled/registered patient via the enrollment/registration process (e.g., via the registration module 270). Or, the server 100 (and/or other computing device) may use the biographic information to identify an existing patient profile for a patient and update the profile with the communication preferences. Accordingly, the server 100 (and/or other computing device) may create and/or store various patient profiles and communication preferences. Via the communication preferences, the location of mobile devices 105 for enrolled/registered patients can be monitored to provide the corresponding patients with messages, for example, to remind them to pick up prescriptions.

Continuing with the above example, John Smith may provide the following as part of his communication preferences: (1) Email: john.smith@mail.com; (2) Text: (505) 777-7777; and/or (3) Software Application. The server 100 (and/or other computing device) may create a patient profile for John Smith or use his biographic information to identify an existing patient profile.

### 2. Geofences

In one embodiment, as indicated, to provide location-based and time-relevant messages to patients, the location of an enrolled/registered patient's mobile device 105 can be monitored. Moreover, the location of an enrolled/registered patient's mobile device 105 can be monitored with regard to one or more care provider locations, such pharmacies at which prescriptions can be or have been filled. To do so, a computing device (e.g., server 100, mobile device 105, and/or care provider computing device 110) may be used to define one or more geofences around one or more geographic areas (e.g., one or more care provider locations).

In one embodiment, the geofences may be defined to substantially surround various geographic areas associated with care providers, such as substantially surrounding countries, regions, states, counties, cities, towns, interstates, roads, streets, avenues, ways, exit and entrance ramps, shopping centers, buildings, plots of land, care provider locations, and/or the like. The geofences may be defined, for example, by the latitude and longitude coordinates associated with various points along the perimeter of the geographic areas. Alternatively, geofences may be defined based on latitude and longitude coordinates of the center, as well as the radius, of the geographic areas. The geographic areas, and therefore the geofences, may be any shape including, but not limited to, a circle, square, rectangle, an irregular shape, and/or the like. Moreover, the geofenced areas need not be the same shape or size. Accordingly, any combination of shapes and sizes may be used in accordance with embodiments of the present invention. Similarly, a geofence may overlap or reside wholly within another geofence.

Continuing with the above example, John Smith may define a two-mile geofence around his primary pharmacy for filling prescriptions (e.g., CVS Caremark Store (Store No. 20821943) 1943 Peachtree Road Northeast, Atlanta, Ga. 30309). In another embodiment, each care provider may define one or more geofences around their respective locations. In this example, the geofences defined by the care providers may be selected by patients for use with location-based services. As will be recognized, a variety of other techniques and approaches may be used with embodiments of the present invention.

In one embodiment, once at least one geofence has been defined, the coordinates (and/or similar methods for defining the geofenced areas) may be stored in a database associated with, for example, a server 100, a care provider computing device 110, and/or a mobile device 105 (e.g., via a software application resident on the mobile device 105). Thus, as a mobile device's 105 location changes (e.g., by a patient carry the mobile device 105 with him as he drives, walks, or bikes), a computing device (e.g., server 100, mobile device 105, and/or care provider computing device 110) can monitor its location.

### 3. Healthcare Data and Patient Identification

In one embodiment, a care provider computing device 110 can receive and process prescriptions (e.g., claims data) on a routine, periodic, and/or continuous basis. Prescriptions may be used to request certain quantities of one or more medications (Block 305 of FIG. 3). To assist in processing prescriptions, each prescription may include information, such as the patient's name, address, date of birth, medical/customer identification number, health insurance information, Social Security number, and/or the like. The care provider computing device 110 can process the prescriptions and then transmit claims data for the prescriptions to the server 100 (and/or other computing device) for processing, storage, and/or payment. In one embodiment, the server 100 can receive the claims data on a routine, periodic, and/or continuous basis (Block 305 of FIG. 3).

In one embodiment, in addition to receiving claims data, the server 100 (and other computing entities) may also receive or have access to longitudinal healthcare data for patients. Longitudinal healthcare data may be received from, for example, an electronic medical record (EMR) of a patient or from other data known about the patient from available sources, or from information provided by patients. Thus, the longitudinal healthcare data may also include historical data from a patient's medical records. For example, the longitudinal healthcare data may indicate a condition (and/or conditions) for which the patient is being treated.

In one embodiment, healthcare data (which may include claims data and/or longitudinal healthcare data) may be used to identify enrolled/registered patients and trigger various events. For example, healthcare data may be used to trigger (a) monitoring the location of a mobile device 105 corresponding to a patient and/or (b) generating, queueing, and/or providing messages to a mobile device 105 of a patient. To do so, healthcare data (which may include claims data and/or longitudinal healthcare data) may be analyzed in a master patient index to identify patients enrolled/registered for location-based services. For the identified patients, their healthcare data may be used to identify prescriptions associated with patients enrolled/registered for location-based services (e.g., such patients may have their profiles flagged to receive messages based on their real-time locations as well as information found in their healthcare data). For example, healthcare data may indicate (and/or be used to determine) that an enrolled/registered patient (a) has had a prescription written, (b) has requested that a prescription be filled, and/or (c) has had a prescription filled by a care provider but has not yet picked up the prescription. In this example, such an indication (and/or determination) may trigger monitoring the location of a mobile device 105 corresponding to the patient. Then, when the mobile device enters a geofenced area of a care provider associated with filling a prescription, for example, the server 100 (and/or other computing device) can provide messages to the mobile device 105 regarding the prescription, incentives from the care provider, and/or other information. In another embodiment, such an indication may trigger generating, queueing, and/or providing messages to a mobile device 105 of the patient. In various embodiments, such techniques may be used to identify patients enrolled/registered for location-based services and, for example, who need to pick up a prescription from a care provider.

Continuing with the above example, John Smith may have had a prescription for cholesterol medication filled at a CVS Caremark Store (Store No. 20821943). The healthcare data (which may include claims data and/or longitudinal healthcare data) may indicate (and/or be used to determine) that the CVS Caremark Store (Store No. 20821943) has received, processed, and/or filled the prescription for John Smith. Using this healthcare data, the server 100 (and/or care provider computing device 110) may determine whether John Smith is enrolled/registered for location-based services. After (e.g., in response to) determining that John Smith is enrolled/registered for location-based services, the server 100 (and/or care provider computing device 110) may trigger monitoring the location of John Smith's mobile device 105. Then, when John Smith's mobile device 105 (e.g., by John carrying the mobile device 105 on his person as he drives, walks, or bikes) enters a geofenced area associated with the CVS Caremark Store (Store No. 20821943), the server 100 (and/or other computing device) can provide messages to John Smith's mobile device 105 regarding the prescription, incentives, and/or other information.

### 4. Location Monitoring

In one embodiment, as indicated, healthcare data may be used to trigger monitoring the location of one or more mobile devices 105 (Block 310 of FIG. 3). Monitoring the location of a mobile device 105 may be performed using a variety of techniques and approaches. For example, a mobile device 105 may routinely, periodically, and/or continuously monitor its location via a software application resident on the mobile device 105. Thus, the mobile device 105 (e.g., via a software application resident on the mobile device 105) can determine when it enters a geofenced area associated with a care provider from which the patient needs to, for example, pick up a prescription. In such an embodiment, when the mobile device 105 determines that it has entered a relevant geofenced area, the mobile device 105 may transmit a message to the server 100 (and/or care provider computing device 110) that indicates the mobile device 105 has entered the geofenced area (Block 315 of FIG. 3). After receiving the indication/notification from the mobile device 105, the server 100 (and/or other computing device) can provide messages to the mobile device 105 regarding the prescription, incentives, and/or other information. In one embodiment, this approach may allow location-based, and/or time-relevant messages to be provided to patients.

Continuing with the above example, because John Smith had a prescription for cholesterol medication filled at a CVS Caremark Store (Store No. 20821943) and he is enrolled/registered for location-based services, John Smith's mobile device 105 may monitor its location with regard to the CVS Caremark Store (Store No. 20821943) and its corresponding two-mile geofenced area. In this example, when John Smith's mobile device 105 (e.g., by John carrying the mobile device 105 on his person as he drives, walks, or bikes) determines that it has entered the two-mile geofenced area associated with the CVS Caremark Store (Store No. 20821943) and notifies the server 100, the server 100 (and/or other computing device) can provide messages to John Smith's mobile device 105 regarding his prescription, incentives from CVS, and/or other information.

In another example, a mobile device 105 may routinely, periodically, and/or continuously transmit location data to the server 100 (and/or other computing device). Using the routinely, periodically, and/or continuously received location data, the server 100 (e.g., via the location module 250) can monitor the mobile device's 105 location and determine when the mobile device 105 enters a geofenced area associated with a care provider (Block 315 of FIG. 3). After determining that the mobile device 105 has entered a geofenced associated with a care provider that has filled a prescription for the patient, the server 100 (and/or other computing device) can provide messages to the mobile device 105 regarding the prescription, incentives, and/or other information.

As will be recognized, a variety of other approaches and techniques can be used to adapt to various needs and circumstances. Thus, these examples are provided for illustrative purposes and are not limiting to embodiments of the present invention.

### 5. Messages

In one embodiment, after determining that a mobile device 105 for an enrolled/registered patient has entered a geofenced area associated with a care provider (e.g., a pharmacy at which a prescription for the patient has been filled or picked up), the server 100 (and/or care provider computing device 110) may generate (and/or select) one or more messages to be provided to the patient's mobile device 105 (Block 320 of FIG. 3). The messages may be in compliance with various message parameters and/or include a variety of information, such as information related to the patient's prescription and/or the patient's healthcare data. The messages may also include information for items related to current weather, seasonal, and/or environmental conditions. Additionally or alternatively, the messages may include information about incentives being offered by a care provider.

In one embodiment, if healthcare data indicates (and/or is used to determine) that an enrolled/registered patient has had a prescription filled by a care provider but has not yet picked up the prescription, the server 100 (and/or care provider computing device 110) may generate (and/or select) and provide (e.g., transmit) a message that reminds the patient that the prescription is ready to be picked up from the care provider. For instance, continuing with the above example as shown in FIG. 5A, the server 100 may provide a message (e.g., text message, email message, voice message, and/or message viewed using a software application resident on the mobile device 105) to John Smith's mobile device 105 for display when the mobile device 105 is within the two-mile geofenced area substantially surrounding the CVS Caremark Store (Store No. 20821943). In this example, the message provided to the mobile device 105 may read “John, Your prescription is ready. We are only two miles away and are open until 10:00 pm. Your Care Provider.”

In another embodiment, if healthcare data indicates (and/or is used to determine) that an enrolled/registered patient has picked up a prescription from a care provider, the server 100 (and/or care provider computing device 110) may include one or more reminders for the patient when the mobile device 105 is within a geofenced area associated with the care provider. The reminders may be in accordance with various message parameters. For instance, the message parameters may indicate that refill reminders should be provided when (a) a mobile device 105 for a patient is within an appropriate geofence but (b) not more than five days before the prescription is due to be refilled or three days before the prescription is due to be refilled, whichever comes first. In this example, as shown in FIG. 5B, the server 100 may provide a message (e.g., text message, email message, voice message, and/or message viewed using a software application resident on the mobile device 105) to John Smith's mobile device 105 for display when the mobile device 105 within the two-mile geofenced area substantially surrounding the CVS Caremark Store (Store No. 20821943). The message provided to the mobile device 105 may read “John, This is a reminder to refill your cholesterol medication. It has been 28 days since your last refill. Your Care Provider.”

Similarly, in another embodiment, if healthcare data indicates (and/or is used to determine) that an enrolled/registered patient has picked up a prescription from a care provider, the server 100 (and/or care provider computing device 110) may include one or more incentives (to visit the care provider) for the patient when the mobile device 105 is within a geofenced area associated with the care provider. The incentives may also be related to conditions indicated in the patient's healthcare data (e.g., from the EMR). The incentives may be related to current weather, seasonal, and/or environmental conditions. For instance, an incentive for a preventative allergy medication may be provided on days with poor air quality and/or a high pollen count. In another embodiment, incentives may be related to sales or discounts currently being offered by the care provider. In this example, as shown in FIG. 5C, the server 100 may provide a message (e.g., text message, email message, voice message, and/or message viewed using a software application resident on the mobile device 105) to John Smith's mobile device 105 for display when the mobile device 105 within the two-mile geofenced area substantially surrounding the CVS Caremark Store (Store No. 20821943). The message provided to the mobile device 105 may read “John, We have allergy medicine on sale, e.g., eye drops are 50% off the retail price today. Your Care Provider.”

In another embodiment, if a patient does not pickup a filled prescription before a predetermined time period lapses (e.g., two weeks), the server 100 (and/or care provider computing device 110) may generate (and/or select) one or more messages to be provided to the patient's mobile device 105 regardless of the mobile device's 105 location (Block 320 of FIG. 3). For example, if the healthcare data indicates (and/or is used to determine) that an enrolled/registered patient has had a prescription filled by the care provider but has not yet picked up the prescription within two weeks from the time the prescription was filled, the server 100 (and/or care provider computing device 110) may generate (and/or select) a message that reminds the patient that the prescription is ready to be picked up from the care provider. For instance, the server 100 may provide a message (e.g., text message, email message, voice message, and/or message viewed using a software application resident on the mobile device 105) to John Smith's mobile device 105 for display two weeks after the prescription was filled regardless of the mobile device's 105 location (not shown). In this example, the message may read “John, Come on in. Your prescription is ready. We are open until 10:00 pm. Your Care Provider.”

In various embodiments, these concepts may enable care providers to provide location-based, content-relevant, patient-specific, and/or time-relevant messages to patients. As will be recognized, a variety of other approaches and techniques can be used to adapt to various needs and circumstances. Thus, these examples are provided for illustrative purposes and are not limiting to embodiments of the present invention.

### IV. CONCLUSION

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing at least one message to a patient, the method comprising:
receiving healthcare data for a prescription, wherein the healthcare data (a) identifies a patient associated with the prescription and (b) a care provider associated with filling the prescription;
monitoring the location of a mobile device of the patient to determine whether the mobile device has entered a geofenced area associated with the care provider;
after determining the mobile device has entered the geofenced area associated with the care provider, generating a message for the patient; and
providing the message to the mobile device of the patient.

2. The method of claim 1 further comprising storing communication preferences for the patient that identify at least one communication format and at least one electronic destination address to be used in providing messages to the mobile device of the patient.

3. The method of claim 2, wherein the at least one communication format is selected from the group consisting of a text message, an email message, a voice message, and a message viewed using a software application resident on the mobile device.

4. The method of claim 1, wherein the message comprises information selected from the group consisting of (a) an incentive based at least in part on the healthcare data, (b) a reminder that the prescription needs to be picked up, and (c) a reminder that the prescription needs to be refilled.

5. The method of claim 4, wherein (a) the message is an incentive based at least in part on the healthcare data and (b) the incentive comprises a discount for purchasing an item having a correlation to current weather, seasonal, or environmental conditions.

6. The method of claim 1 further comprising receiving input defining the geofenced area associated with the care provider, wherein the geofenced area substantially surrounds a location of the care provider.

7. The method of claim 1 further comprising determining whether the patient is registered for location-based services.

8. A computer program product for providing at least one message to a patient, the computer program product comprising at least one computer-readable storage medium having computer-readable program code portions stored therein, the computer-readable program code portions comprising:
an executable portion configured to receive healthcare data for a prescription, wherein the healthcare data (a) identifies a patient associated with the prescription and (b) a care provider associated with filling the prescription;
an executable portion configured to monitor the location of a mobile device of the patient to determine whether the mobile device has entered a geofenced area associated with the care provider;
an executable portion configured to, after determining the mobile device has entered the geofenced area associated with the care provider, generate a message for the patient; and
an executable portion configured to provide the message to the mobile device of the patient.

9. The computer program product of claim 8 further comprising an executable portion configured to store communication preferences for the patient that identify at least one communication format and at least one electronic destination address to be used in providing messages to the mobile device of the patient.

10. The computer program product of claim 9, wherein the at least one communication format is selected from the group consisting of a text message, an email message, a voice message, and a message viewed using a software application resident on the mobile device.

11. The computer program product of claim 8, wherein the message comprises information selected from the group consisting of (a) an incentive based at least in part on the healthcare data, (b) a reminder that the prescription needs to be picked up, and (c) a reminder that the prescription needs to be refilled.

12. The computer program product of claim 11, wherein (a) the message is an incentive based at least in part on the healthcare data and (b) the incentive comprises a discount for purchasing an item having a correlation to current weather, seasonal, or environmental conditions.

13. The computer program product of claim 8 further comprising an executable portion configured to receive input defining the geofenced area associated with the care provider, wherein the geofenced area substantially surrounds a location of the care provider.

14. The computer program product of claim 8 further comprising an executable portion configured to determine whether the patient is registered for location-based services.

15. An apparatus comprising at least one processor and at least one memory including computer program code, the at least one memory and the computer program code configured to, with the processor, cause the apparatus to at least:
receive healthcare data for a prescription, wherein the healthcare data (a) identifies a patient associated with the prescription and (b) a care provider associated with filling the prescription;
monitor the location of a mobile device of the patient to determine whether the mobile device has entered a geofenced area associated with the care provider;
after determining the mobile device has entered the geofenced area associated with the care provider, generate a message for the patient; and
provide the message to the mobile device of the patient.

16. The apparatus of claim 15, wherein the memory and computer program code are further configured to, with the processor, cause the apparatus to store communication preferences for the patient that identify at least one communication format and at least one electronic destination address to be used in providing messages to the mobile device of the patient.

17. The apparatus of claim 16, wherein the at least one communication format is selected from the group consisting of a text message, an email message, a voice message, and a message viewed using a software application resident on the mobile device.

18. The apparatus of claim 15, wherein the message comprises information selected from the group consisting of (a) an incentive based at least in part on the healthcare data, (b) a reminder that the prescription needs to be picked up, and (c) a reminder that the prescription needs to be refilled.

19. The apparatus of claim 18, wherein (a) the message is an incentive based at least in part on the healthcare data and (b) the incentive comprises a discount for purchasing an item having a correlation to current weather, seasonal, or environmental conditions.

20. The apparatus of claim 15, wherein (a) the memory and computer program code are further configured to, with the processor, cause the apparatus to receive input defining the geofenced area associated with the care provider, and (b) the geofenced area substantially surrounds a location of the care provider.

21. The apparatus of claim 15, wherein the memory and computer program code are further configured to, with the processor, cause the apparatus to determine whether the patient is registered for location-based services.
